(19) United States
(12) Patent Application Publication
(10) Pub. No.: US 2002/0156758 A1
(43) Pub. Date: Oct. 24, 2002

(54) System and method for dynamic addition and removal of object interfaces

(76) Inventors: Remi Cote, Hull (CA); David Sellars, Swindon (GB); Maarten Koning, Bloomfield (CA); Kevin McCombe, Ottawa (CA)

Correspondence Address: Patrick Fay, Fay Kaplun & Marcin, LLP, 100 Maiden Lane, 17th Floor, New York, NY, 10038, US

(21) Appl. No.: 09/790,283

(22) Filed: Feb. 22, 2001

(51) Int. Cl. G06F 7/00

(52) U.S. Cl. 707/1

(57) ABSTRACT

A method for adding information to an object, by preparing the object to receive an extension object and attaching, during run-time, the extension object to the object, wherein the extension object includes the information to be added to the object. A system comprising an object, a primary interface including methods which allow information to be added to the object during run-time, wherein the object and the primary interface are compiled with the system and an extension object including information to be added to the object, wherein the extension object is attached to the object during run-time.

### BACKGROUND INFORMATION

Component Object Model (“COM”) refers to a framework for integrating components. This framework supports interoperability and reusability of distributed objects by allowing developers to build systems by assembling reusable components from different software developers which may communicate via COM. In order to interact, the components may expose interfaces which adhere to a binary structure specified by the COM standard. By adhering to this binary structure standard, components written in different languages can interoperate. Building systems with COM allows developers to reap the benefits of maintainability and adaptability from the use of preexisting components. In some instances, COM may be referred to as Distributed COM (“DCOM”), which is an extension to COM which allows processes to spread across a network. In the network environment, components operating on a variety of platforms can interact, as long as DCOM is available within the network environment. Thus, COM aware applications may run on the same computing device, while DCOM aware applications may be spread across a computing network. However, in either case, COM and DCOM may be considered a single technology that provides a range of services for component interaction.

### SUMMARY OF THE INVENTION

A method for adding information to an object, by preparing the object to receive an extension object and attaching, during run-time, the extension object to the object, wherein the extension object includes the information to be added to the object. Furthermore, a system comprising an object, a primary interface including methods which allow information to be added to the object during run-time, wherein the object and the primary interface are compiled with the system and an extension object including information to be added to the object, wherein the extension object is attached to the object during run-time.

### BRIEF DESCRIPTION OF DRAWINGS

FIG. 1 shows a client application using an object through an interface pointer.

FIG. 2 shows a clock emulation object having three interfaces.

FIG. 3 shows an exemplary system with client applications and objects.

FIG. 4 shows an exemplary object having primary interfaces and extensions with extension interfaces.

FIG. 5 shows an exemplary process for the AddInterface method of the IXManager interface.

FIG. 6 shows an exemplary process for the ReleaseInterface method of the IXManager interface.

FIG. 7 shows an exemplary process for the AcquireInterface method of the IXManager interface.

### DETAILED DESCRIPTION

The present invention may be further understood with reference to the following description of preferred exemplary embodiments and the related appended drawings, wherein like elements are provided with the same reference numerals. The exemplary embodiments of the present invention will generally be described throughout this specification using examples of COM objects. However, those skilled in the art will understand that the present invention is not limited to instances where COM objects and interfaces are used. The present invention may be implemented in any system to dynamically add or delete interfaces to an existing object without interfering with the existing objects implementation.

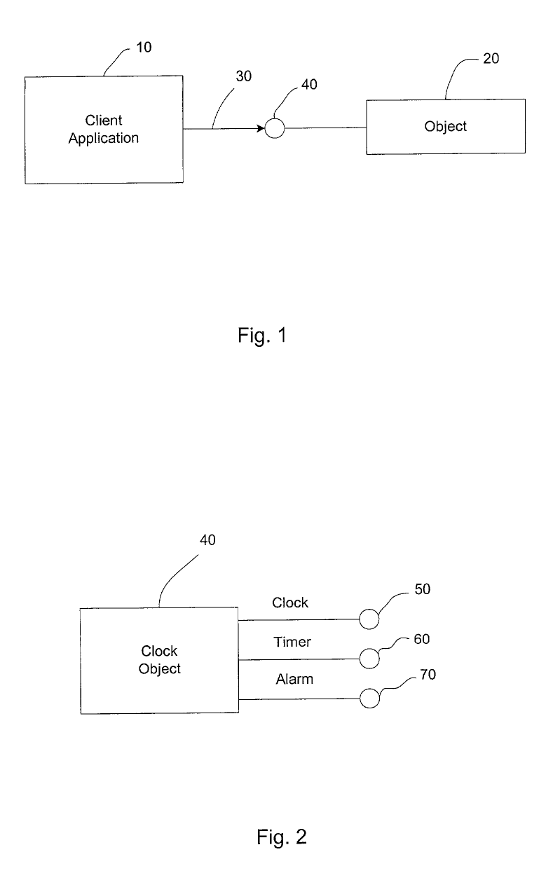

FIG. 1 shows a client application 10 using an object 20 through an interface pointer 30. Services implemented by object 20 are exposed as callable functions through an interface 40 to client application 10 via interface pointer 30. Interface pointer 30 represents the one and only point of contact between client application 10 and object 20. As described above, COM defines a binary structure for the interface between client application 10 and object 20. This binary structure provides the basis for the interoperability between software components written in arbitrary languages. A compiler can reduce the language structures of each of the client application 10 and the object 20 to the binary representation. Because the contact point is the binary representation, the implementation languages for client application 10 and object 20 do not matter. Thus, it is possible to code client application 10 and object 20 in any programming languages that support the binary structure. Object 20 may have internal data not seen by client application 10. Object 20 is exposed to client application 10 only through interface 40, which is accessed via interface pointer 30. Client application 10 can make no assumptions about the internal workings of object 20, other than what can be determined via interface 40.

An interface provides a grouped collection of related methods and a COM object can support any number of interfaces. Each interface is composed of one or more methods, which are functions of the provider that are callable from its clients. For example, FIG. 2 shows a clock emulation COM object 40 having three interfaces, clock interface 50, timer interface 60 and alarm interface 70. Clock interface 50 may provide appropriate methods to allow the setting and reading of the current time. Timer interface 60 may provide stopwatch methods, while alarm interface 70 may provide alarm functions. The COM standard defines one interface, called IUnknown, which must be included in all objects. All other interfaces defined by an application must extend the definition of IUnknown. For example, assuming that clock interface 50 is a COM interface, it would contain the methods of IUnknown as well as any methods defined in the specification of clock interface 50. A COM object may expose one or more interfaces for client applications to use. For example, clock emulation COM object 40 may expose the three interfaces 50-70 described above for multiple client applications to use. Client applications may use the COM provided QueryInterface( ) (“QI”) function to discover the interfaces of a COM object. The client application, using QI, may ask a COM object whether it supports a particular interface.

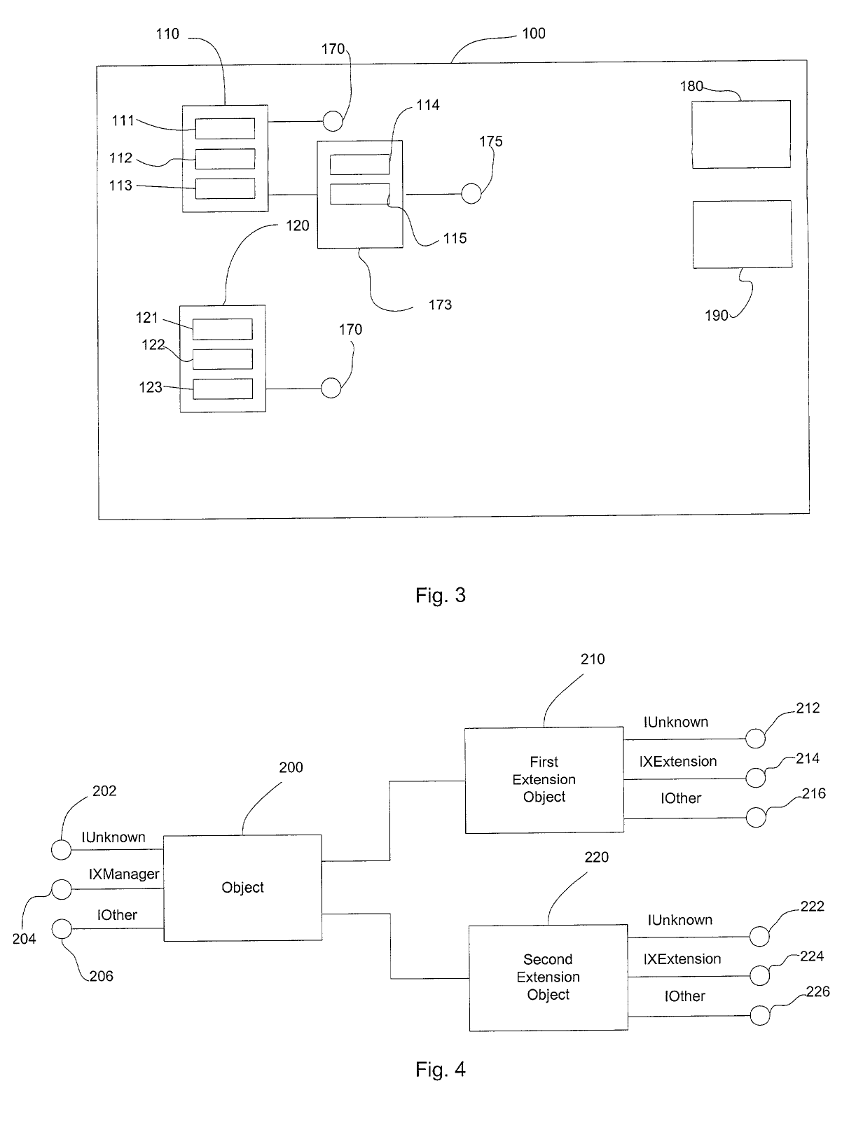

FIG. 3 shows an exemplary system 100 with client applications 180 and 190 and objects 110 and 120. Each of objects 110 and 120 stores a set of information in the form of, for example, information blocks 111-113 and 121-123, respectively. Each of objects 110 and 120 also have primary interface 170. A primary interface is one that is defined for an object at compile time. For example, referring back to FIG. 2, clock interface 50, timer interface 60 and alarm interface 70 are primary interfaces. These are the interfaces that clock object 40 exposes to client applications. Since primary interfaces are defined at compile time, the object is aware of the interface. Referring back to FIG. 3, client applications 180 and 190 may, through primary interface 170, access the information stored by objects 110 and 120. For example, client application 180 may need the information stored in information blocks 121-123 of object 120. By using the methods provided by primary interface 170, client application 180 may have access to information blocks 121-123. Those of skill in the art will understand that this assumes that the methods defined at compile time for primary interface 170 allow for the access to the information blocks. Object 110 is also shown having extension object 173 and extension interface 175 which are added during run time. Therefore, when objects 110 and 120 are compiled, primary interface 170 and its methods are exposed to client applications 180 and 190, but extension object 173 and extension interface 175 are not because they do not exist when objects 110 and 120 are compiled. Extension object 173 and extension interface 175 will only come into existence at a later time (i.e., during run time), if and when they are needed. The purpose of adding extension object 173 and extension interface 175 will be described in greater detail below.

Client application 180 may desire to dynamically store additional information about some or all of objects 110 and 120. For example, in addition to information blocks 111-113 of object 110, client application 180 may desire to store additional information, for example, information blocks 114 and 115 because of some relationship with information blocks 111-113. The reason for this dynamic storage may be, for example, so that client applications 180 and 190 may access all of information blocks 111-115. One manner of storing such additional information would be for client application 180 to replicate object 110 including information blocks 111-113 and then add information blocks 114-115 to the replicated object. However, such replication is not resource efficient because an existing object (e.g., object 110) would be stored multiple times in system 100. The problem of storage becomes more apparent when a client application desires to store additional information about all of objects 110 and 120.

The exemplary embodiment according to the present invention allows the dynamic addition of information to the already existing objects 110 and 120. The process of dynamically adding information, and the corresponding deletion of this information, remains transparent to objects 110 and 120. The information is added by adding new interfaces (e.g., extension interface 175) to objects 110 and 120 at run-time. Those of skill in the art will understand that in the exemplary embodiment of FIG. 3, extension interface 175 is only shown as being added to object 110, but that extension interface 175 or other extension interfaces may be added to object 120. Objects 110 and 120 need no prior knowledge of the added interfaces at compile time. To carry through with the example started above, when client application 180 desires to add information blocks 114 and 115 to object 110, it verifies that object 110 may accept an extension interface. The process of preparing or defining an object so that it may accept extension interfaces will be described in greater detail below. If object 110 can accept extension interfaces, client application 180 adds extension interface 175 and extension object 173 to object 110. The methods associated with extension interface 175 allow for the storage and retrieval of information blocks 114 and 115 which are stored in extension object 173 by other applications, for example client application 190.

Client application 180 and extension interface 175 add information blocks 114 and 115 to object 110. Compiled object 110 is not aware of the presence of these additional information blocks 114 and 115. Applications that desire to access object 110 through extension interface 175 will be exposed to information blocks 111-113 in the compiled object 110 and additional information blocks 114-115 in extension object 173. Information blocks 114 and 115 will only be available to those applications that access object 110 through extension interface 175. If client application 190 were to access object 110 through primary interface 170, object 110 would still appear as originally compiled, i.e., including only information blocks 111-113. Object 110 is not aware that extension interface 175 is an interface it is exposing to applications 180 and 190 in system 100. Object 110 is also not aware that extension object 173 including information blocks 114 and 115 is attached to object 110. When client application 190 has performed its tasks and no longer needs the information in information blocks 114 and 115, extension object 173 and extension interface 175 may be deleted from system 100. In contrast, objects 110 and 120 and primary interface 170 are a permanent part of system 100 until it is recompiled.

FIG. 4 shows exemplary object 200 having primary interfaces 202-206 and extension objects 210 and 220 with extension interfaces 212-216 and 222-226, respectively. In this example, object 200 has the following primary interfaces: IUnknown interface 202, IXManager interface 204 and IOther interfaces 206. Object 200 may be considered a COM object, in which case, as described above, it will have an IUnknown interface 202 by default. IOther interfaces 206 are additional interfaces added to object 200 at compile time, for example, clock interface 50 of FIG. 2. IOther interfaces 206 extend the definition of IUnknown interface 202, i.e., include all the functionality of IUnknown interface 202 plus any additional methods added by IOther interfaces 206. IXManager interface 204 also extends the definition of IUnknown interface 202 and provides the methods allowing object 200 to accept the dynamic addition and deletion of extension interfaces at run time. IXManager interface 204 is not an extension interface that is added during run time, but is rather a primary interface added at compile time that allows the dynamic addition and deletion of extension interfaces at run time. The definition of IXManager interface 204 in Interface Definition Language (“IDL”) may be as follows:

interface IXManager : IUnknown

{
HRESULT AddInterface

(
[in] REFIID iid,
[in] IXExtension* pExtn
);

HRESULT ReleaseInterface

(
[in] REFIID iid
);

HRESULT AcquireInterface

(
[in] REFIID iid,
[out] void** ppv
);

}

Those of skill in the art will understand that the preceding IDL interface definition is only exemplary and there may be numerous manners of implementing the same functionality in an interface. The exemplary IXManager interface 204 provides the functionality that will support the dynamic addition and removal of extension interfaces for object 200. The functionality which is contained in the methods defined in the above IDL interface definition (i.e., AddInterface, ReleaseInterface and AcquireInterface) will be described in greater detail below.

When object 200 implements IXManager interface 204 it may accept extension objects and extension interfaces at run time. In this example, object 200 has implemented IXManager interface 204 and it has a first extension object 210 and a second extension object 220. Similar to an originally compiled object (e.g., object 200), first extension object 210 and second extension object 220 will expose interfaces to the client applications in the system. Once again, using COM objects as an example, first extension object 210 and second extension object 220 will have IUnknown interfaces 212 and 222, respectively. First extension object 210 and second extension object 220 will also have IXExtension interfaces 214 and 224, respectively. The definition of IXExtension interfaces 214 and 224 in IDL may be as follows:

interface IXExtension : IUnknown

{
HRESULT Connect ([in] IUnknown* punkOuter);
HRESULT Disconnect ([in] IUnknown* punkOuter);
HRESULT IsIID ([in] REFIID iid);
};

Those of skill in the art will understand that the preceding IDL interface definition is only exemplary and there may be numerous manners of implementing the same functionality in an interface. The functionality of IXExtension will become clear with the description of the functionality of the IXManager which will be described below. IOther interfaces 216 and 226 are additional interfaces that may be implemented by the first and second extension objects 210 and 220. Each of these IOther interfaces 216 and 226 will inherit from IXExtension interfaces 214 and 224, respectively, meaning that all the functionality of IXExtension interfaces 214 and 224 will be included within IOther interfaces 216 and 226. When an application uses one of the other interfaces (e.g., other interface 216), to access object 200 it will also see the information contained in the associated extension object 210. However, as described above, first and second extension objects 210 and 220 and the associated interfaces 212-216 and 222-226 are transparent to object 200.

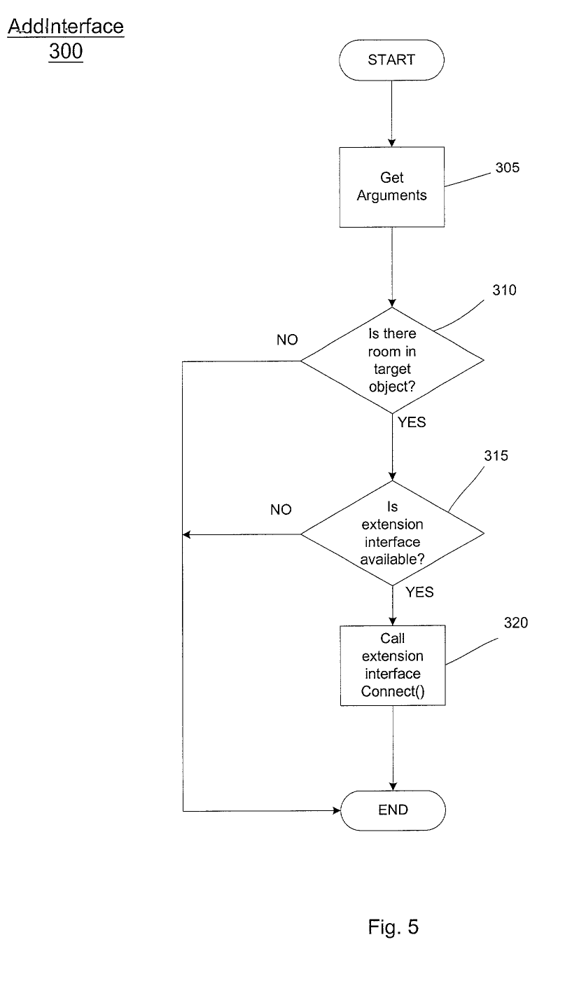

Referring to FIG. 5, an exemplary process will be described for the AddInterface method 300 shown in the exemplary IDL definition of the IXManager interface 204 described above. In step 305, the process gets arguments for the method. AddInterface method 300 takes two arguments, the Interface ID (“IID”) of the extension interface being added and the IXExtension pointer of the extension interface itself. The process then continues to step 310 where it is determined whether there is room available in the target object to add the extension interface. Each object may have a finite number of extension objects which can be added to the object at any one point in time. If the target object does not have enough space to accommodate additional extension interfaces at this time the process ends. If the target object has space to accommodate the extension interface, the process continues to step 315 where it is determined if the extension interface is connected to a different object (i.e., not the target object). If the extension interface is currently connected to a different object, the process will end. For example, referring back to FIG. 3, if application 180 desires to add extension interface 175 to object 110 (the target object), but extension interface 175 has already been connected to object 120, AddInterface method 300 will fail because the extension interface is already connected to a different object (i.e., object 120 in this example). If the extension interface is available, the process continues to step 320 where AddInterface method 300 calls the extension interface's Connect( ) method by passing the object's IUnknown interface to the extension interface. For example, referring back to FIG. 4, when first extension object 210 is to be connected to object 200, the AddInterface method 300 passes IUnknown interface 202 of object 200 to first extension object 210, which subsequently would be IUnknown interface 212.

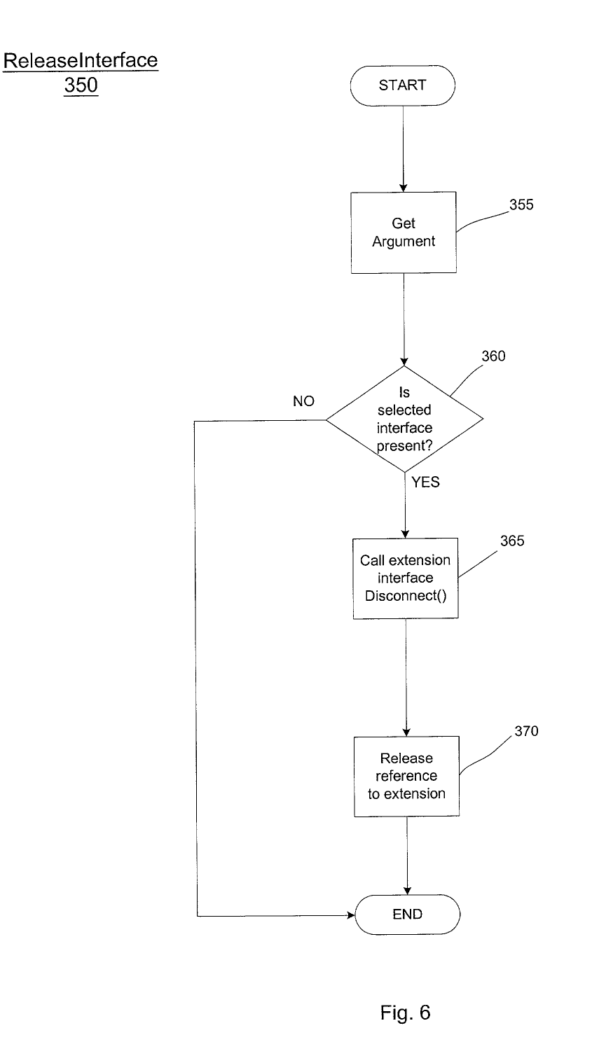

As part of the Connect( ) method, the extension object will keep a count of how many clients are accessing the object through an interface. The purpose of keeping count is so that the extension object is not destroyed or erased from memory until all the clients that are currently accessing the extension object are finished using the extension interface. When the last client is finished using the extension object (i.e., the count goes to zero), it may be destroyed. This destruction or release of an extension object will be described with reference to FIG. 6. Those of skill in the art will understand that in certain instances it may not be in the best interest of the system to release or destroy an object when a client is finished with the object. For example, if an extension object is accessed during an interrupt routine, the release of an extension object may cause a problem for the system because the release action is unbounded which may cause a problem in the execution of the interrupt routine. In such cases, the Connect( ) method may not cause the extension object to increment the counter. If the counter is not incremented, it consequently will not be decremented to zero, and therefore the extension object will not be destroyed.

Referring to FIG. 6, an exemplary process will be described for the ReleaseInterface method 350 shown in the exemplary IDL definition of the IXManager interface 204 described above. In step 355, the process gets the argument for the method. ReleaseInterface method 350 takes one argument, the Interface ID (“IID”) of the extension interface to be removed. The process then continues to step 360 to determine whether the selected interface is present in the set of extension interfaces connected to an object. If the selected interface is not connected to the object, the process ends. If the selected interface is connected, the process continues to step 365 where the disconnect method of the extension interface is called. The extension interface disconnect method will remove the extension interface by indicating to the extension interface that it is no longer attached to the object. The process then continues to step 370 where the object releases its reference to the extension interface.

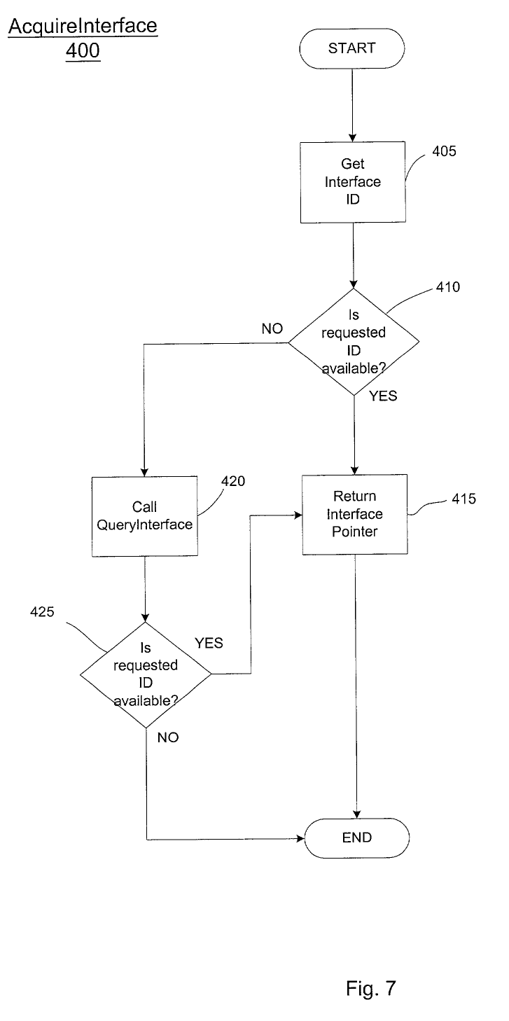

Referring to FIG. 7, an exemplary process will be described for the AcquireInterface method 400 shown in the exemplary IDL definition of the IXManager interface 204 described above. The AcquireInterface method 400 allows a client application to query for the dynamically added extension interfaces that an object may support. For example, referring back to FIG. 3, after extension interface 175 has been added to object 110, client application 190 may query object 110 using AcquireInterface method 400 to determine which extension interfaces object 110 supports. In this example, AcquireInterface method 400 will return that object 110 supports extension interface 175. Referring back to FIG. 7, in step 405 the interface ID that the application desires to access is determined. In step 410, it is determined whether the interface ID is available. To determine whether the interface I) is available, the process scans all the extension interfaces for the requested interface ID using a method of IXExtension. The method allows the process to look at the interface IDs of all the extension interfaces that have exposed the IXExtension interface. If the interface ID is found, the process continues to step 415 where the interface pointer of that extension interface is returned to the application. When the application has the extension interface pointer, it may begin to access the information in the extension object.

If in step 410, the requested interface ID is not found the process continues to step 420, where the QueryInterface( ) method of the main object is called. Upon calling the QueryInterface( ) method of the main object, the process continues to step 425 to determine if the requested interface is one of the compiled interfaces attached to the main object. If it is not the process ends because the requested interface ID does not exist in the system. If the requested interface ID is one of the compiled interfaces, the process loops back to step 415 were the interface pointer of the compiled extension is returned to the application, so it may access the information in the main object. Those of skill in the art will understand that in step 410, if the requested interface ID is not available the process may end at this point because the requested interface does not exist. For example, if the present invention was implemented in a system that did not implement COM, the system may not support the QueryInterface( ) method.

The present invention may also be implemented in such a manner that an object is compiled only with the interfaces required for the addition of dynamic interfaces during run-time. For example, referring back to FIG. 2, it may be possible that clock object 40 is compiled only with the IUnknown and IXManager interfaces. These interfaces allow clock object 40 to dynamically accept other interfaces during run-time. Then, during run-time, other interfaces may be added on an as-needed basis. For example, clock interface 50 may be needed during run-time and it can be added to clock object 40, and then released when it is no longer needed. In this manner, the user does not need to anticipate all the interfaces that a particular object may need and include the interfaces at the time of compiling the system.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

what is claimed is:

1. A method for adding information to an object, comprising the steps of:
preparing the object to receive an extension object; and
attaching, during run-time, the extension object to the object, wherein the extension object includes the information to be added to the object.

2. The method of claim 1, further comprising the step of:
attaching an extension interface to the extension object, wherein an application accesses the information through the extension interface.

3. The method of claim 2, further comprising the step of:
destroying the extension object when the application is finished accessing the information.

4. The method of claim 1, wherein the preparation of the object occurs prior to run-time.

5. The method of claim 1, wherein the adding of the information is transparent to the object.

6. The method of claim 1, wherein the object is compiled with original information and at least one primary interface.

7. A method for adding an extension interface to an object, comprising the steps of:
defining a primary interface including a first set of methods which allow extension interfaces to be added to the object during run-time;
coupling the primary interface to the object;
attaching, during run-time, an extension interface to the object, wherein the extension interface includes a second set of methods for interacting with the object.

8. The method of claim 7, further comprising the steps of:
accessing the object through the extension interface; and
interacting with the object using the second set of methods included in the extension interface.

9. The method of claim 7, wherein the defining step and the coupling step occur prior to run-time.

10. The method of claim 7, further comprising the step of:
destroying the extension interface when the interacting step is complete.

11. A system, comprising:
an object;
a primary interface including methods which allow information to be added to the object during run-time, wherein the object and the primary interface are compiled with the system; and
an extension object including information to be added to the object, wherein the extension object is attached to the object during run-time.

12. The system of claim 11, further comprising:
an extension interface coupled to the extension object, wherein the extension interface includes a set of methods for interacting with the object.

13. The system of claim 12, wherein an application accesses the information contained in the extension object via the extension interface.

14. A system, comprising:
an object;
an IXManager interface, wherein the object and the IXManager interface are compiled with the system; and
an IXExtension interface, attached to the object during run-time, including a set of methods for interacting with the object, wherein the IXManager interface includes methods which allow the IXExtension interface to be added to the object during run-time.

15. The system of claim 14, further comprising:
at least one extension interface attached to the object during run-time, wherein the at least one extension interface inherits the set of methods for interacting with the object from the IXExtension interface.

16. The system of claim 15, wherein an application queries the object to determine the at least one extension interface supported by the object.

17. The system of claim 14, wherein additional information may be stored in the object after the IXExtension interface is attached to the object.

18. The system of claim 17, wherein an application may access the additional information.

19. A system, comprising:
an IXManager interface compiled with an object; and
an IXExtension interface, wherein the IXManager interface includes an addition method to add the IXExtension interface to the object without compiling.

20. The system of claim 19, wherein the IXManager includes a release method to release the IXExtension interface from the object without compiling.

21. The system of claim 19, further comprising:
at least one extension interface connected to the object without compiling, wherein the IXExtension interface includes a connect method for attaching the at least one extension interface to the object.

22. The system of claim 21, wherein the IXExtension interface includes a disconnect method for disconnecting the at least one extension interface from the object without compiling.

23. The system of claim 21, wherein each of the at least one extension interfaces has a unique identifier.

24. The system of claim 24, wherein the IXManager includes a query method to allow an application to query the object to determine the at least one extension interface supported by the object, the query being performed based on the unique identifier of the at least one extension interface.
